(19) United States
(12) Patent Application Publication
(10) Pub. No.: US 2025/0080645 A1
(43) Pub. Date: Mar. 6, 2025

(54) CALL DATA TRANSMISSION METHOD AND APPARATUS THEREOF

(71) Applicant: MEDIATEK INC., Hsinchu City (TW)

(72) Inventors: Jie HAO, Beijing (CN); Guoyi ZHAO, Beijing (CN); Yizheng YANG, Beijing (CN)

(21) Appl. No.: 18/818,922

(22) Filed: Aug. 29, 2024

(30) Foreign Application Priority Data
Aug. 31, 2023 (CN) 202311117473.5
Oct. 30, 2023 (CN) 202311420218.8

(51) Int. Cl. H04M 3/22; H04M 7/00

(52) U.S. Cl. CPC H04M 3/2236; H04M 7/006

(57) ABSTRACT

A call data transmission method is provided. The call data transmission method may include the following steps. An apparatus may establish a first connection and a second connection with a second apparatus. The first connection may be a third generation partnership project (3GPP) connection and the second connection is a Wi-Fi connection, or the first connection may be a Wi-Fi connection and the second connection is a 3GPP connection. The apparatus may also perform a voice call or a video call with the second apparatus through the first connection. The apparatus may also determine whether the first connection meets a quality condition. The apparatus may further transmit data packets of the voice call or the video call to the second apparatus through the first connection and the second connection in the event that the first connection meets a quality condition.

### CROSS-REFERENCE TO RELATED APPLICATIONS

This application claims the benefits of CN patent application No. 202311117473.5 filed on Aug. 31, 2023 and CN patent application No. 202311420218.8 filed on Oct. 30, 2023, the entirety of which are incorporated by reference herein.

### BACKGROUND OF THE INVENTION

### Field of the Invention

The invention generally relates to call data transmission technology, and more particularly, to a call data transmission through two paths (or networks).

### Description of the Related Art

Unless otherwise indicated herein, approaches described in this section are not prior art to the claims listed below and are not admitted as prior art by inclusion in this section.

In a conventional voice call (e.g., voice over LTE (VOLTE) call, voice over NR (VONR) call, or voice over Wi-Fi (VoWiFi) call) transmission technologies, or video call (e.g., video over LTE (ViLTE) call, video over NR (ViNR) call, or video over Wi-Fi (ViWiFi) call) transmission technologies, the voice call or the video call may only be performed through one connection (e.g., third generation partnership project (3GPP) connection or Wi-Fi connection). When the quality of the connection declines, packet loss may occur. As a result, the quality of the voice call or the video call may also become worse, or the voice call or the video call may be dropped.

Therefore, how to maintain the quality of a voice call or a video call is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to performing voice call or video call through two different paths (or networks) with respect to user equipment and network apparatus in mobile communications. It is believed that the above-described issue would be avoided or otherwise alleviated by implementing one or more of the proposed schemes described herein.

An embodiment of the invention provides a call data transmission method. The call data transmission method may be applied to an apparatus. The call data transmission method may include the following steps. The apparatus may establish a first connection and a second connection with a second apparatus. The first connection may be a third generation partnership project (3GPP) connection and the second connection is a Wi-Fi connection, or the first connection may be a Wi-Fi connection and the second connection is a 3GPP connection. The apparatus may also perform a voice call or a video call with the second apparatus through the first connection. The apparatus may also determine whether the first connection meets a quality condition. The apparatus may further transmit data packets of the voice call or the video call to the second apparatus through the first connection and the second connection in the event that the first connection meets a quality condition.

In some embodiments, the quality condition may be at least one of that the quality of the first connection is lower than a threshold, and that the latency of the first connection is longer than a second threshold.

In some embodiments, the apparatus may transmit internet protocol (IP) information and port number information of the apparatus to a call exchange server through the Wi-Fi connection.

In some embodiments, in the event that the first connection is a 3GPP connection and the second connection is a Wi-Fi connection, the apparatus may receive first response data packets associated with the voice call or the video call from the second apparatus through the 3GPP connection, and receive second response data packets associated with the voice call or the video call from the second apparatus through a call exchange server.

In some embodiments, the apparatus may merge the first response data packets and the second response packets, and play the merged data packets to perform the voice call or the video call.

In some embodiments, the apparatus may compare the first response data packets to the second response data packets, and remove redundancy data packets between the first response data packets and the second response data packets.

In some embodiments, the second response data packets may be encoded based on a security real-time transport protocol (SRTP).

In some embodiments, the apparatus may decode the second response packets to convert SRTP data packets into real-time transport protocol (RTP) data packets.

In some embodiments, the apparatus may stop transmitting the data packets of the voice call or the video call to the second apparatus through the second connection in the event that the first connection does not meet the quality condition, and perform the voice call or the video call with the second apparatus only through the first connection.

An embodiment of the invention provides an apparatus. The apparatus may include a transceiver and a processor. The transceiver may be configured to perform wireless transmission and reception to and from a network node. The processor may be coupled to the transceiver. The processor may perform the following operations. Said operations include establishing a first connection and a second connection with a second apparatus, wherein the first connection is a third generation partnership project (3GPP) connection and the second connection is a Wi-Fi connection, or the first connection is a Wi-Fi connection and the second connection is a 3GPP connection. Said operations include performing a voice call or a video call with the second apparatus through the first connection. Said operations include determining whether the first connection meets a quality condition. Said operations include transmitting, via the transceiver, data packets of the voice call or the video call to the second apparatus through the first connection and the second connection in the event that the first connection meets a quality condition.

Other aspects and features of the invention will become apparent to those with ordinary skill in the art upon review of the following descriptions of specific embodiments of the call data transmission method and the apparatus.

### BRIEF DESCRIPTION OF THE DRA WINGS

The invention will become more fully understood by referring to the following detailed description with reference to the accompanying drawings, wherein:

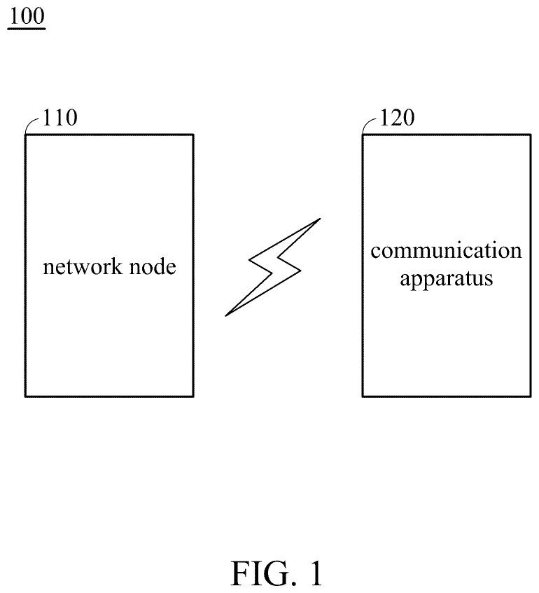

FIG. 1 is a block diagram of a wireless communication system 100 according to an embodiment of the application.

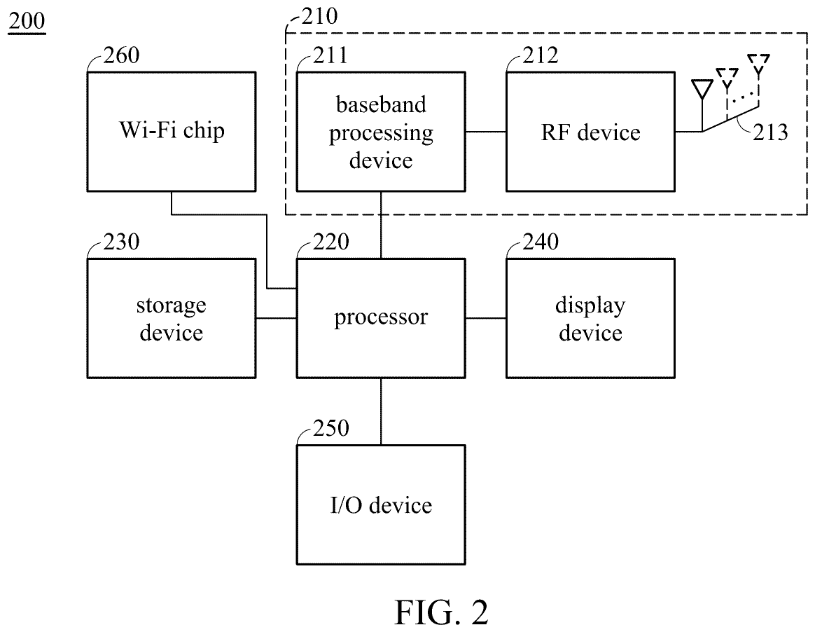

FIG. 2 is a block diagram illustrating a communication apparatus 200 according to an embodiment of the application.

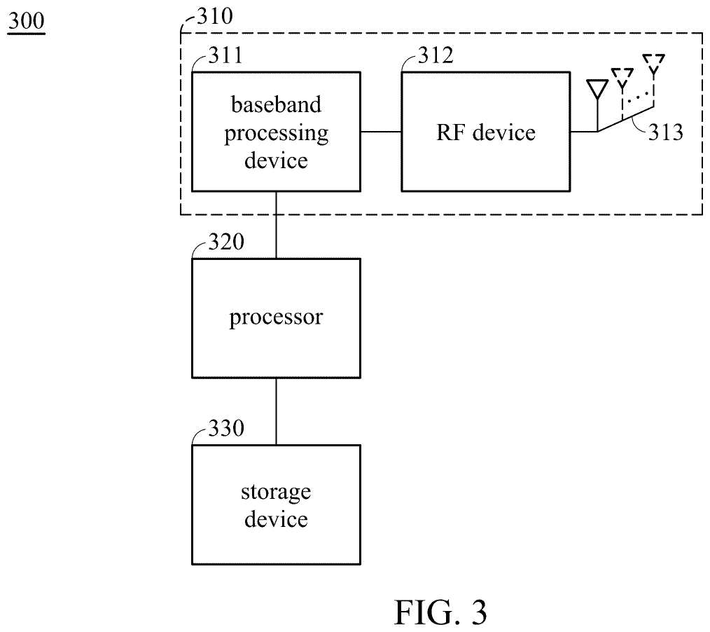

FIG. 3 is a block diagram illustrating a network node 300 according to an embodiment of the application.

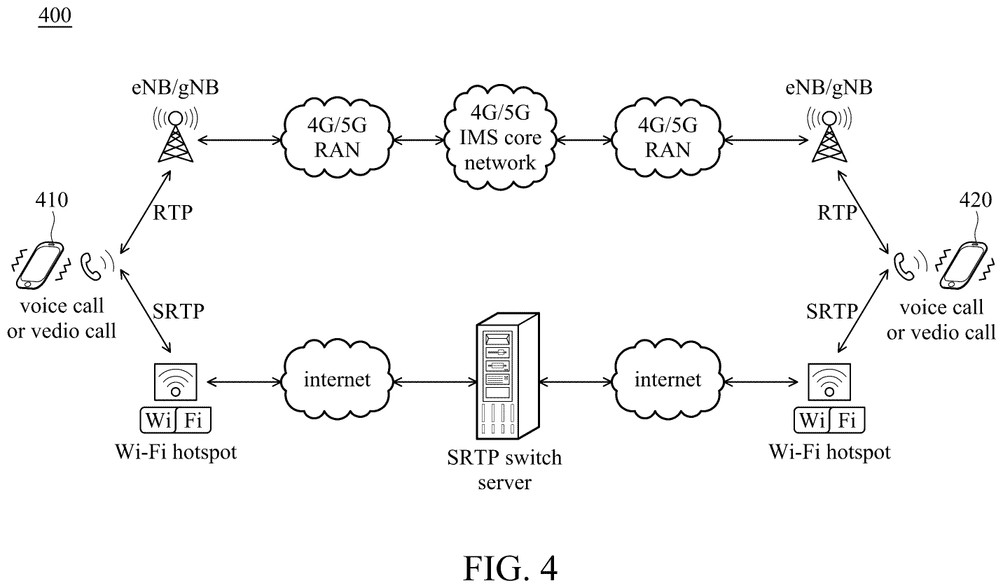

FIG. 4 is a schematic diagram illustrating a dual-path call data transmission 400 according to an embodiment of the invention.

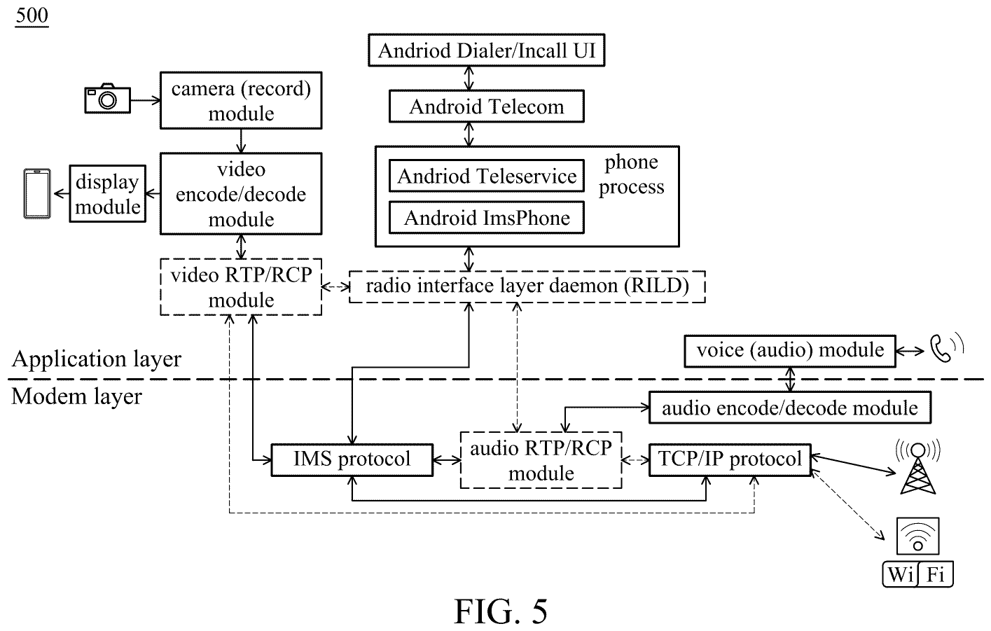

FIG. 5 is a schematic diagram illustrating dual-path call data transmission 500 on an Android platform according to an embodiment of the invention.

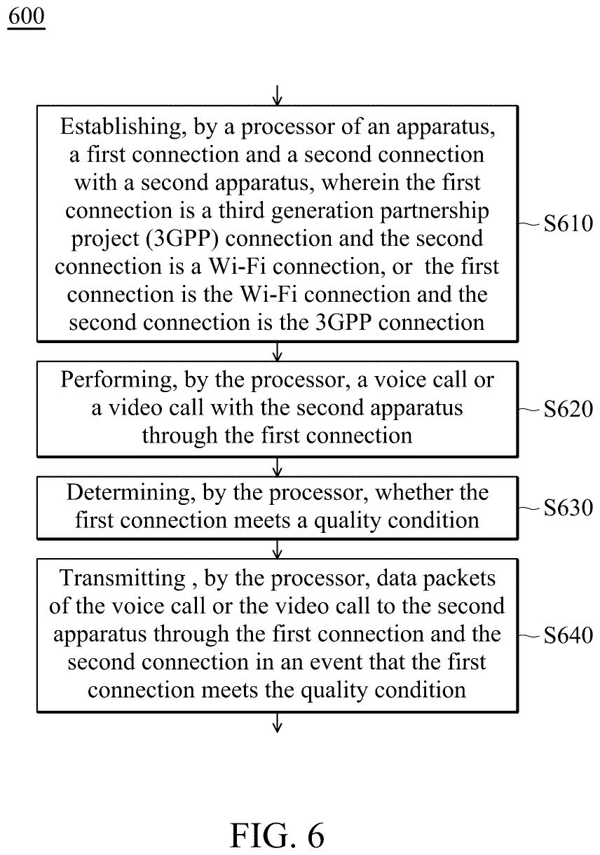

FIG. 6 is a flow chart illustrating a call data transmission method 600 according to another embodiment of the invention.

### DETAILED DESCRIPTION OF THE DISCLOSURE

The following description is of the best-contemplated mode of carrying out the invention. This description is made for the purpose of illustrating the general principles of the invention and should not be taken in a limiting sense. The scope of the invention is best determined by reference to the appended claims.

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the network node 110 may be an entity compatible with the Institute of Electrical and Electronics Engineers (IEEE) 802.11 standards to provide and manage the access to the wireless medium for the communication apparatus 120.

In the embodiments of the invention, the communication apparatus 120 may be a user equipment (UE), a non-AP station (STA), a smartphone, Personal Data Assistant (PDA), pager, laptop computer, desktop computer, wireless handset, or any computing device that includes a wireless communications interface. In addition, the communication apparatus 120 may be an entity compatible with the Institute of Electrical and Electronics Engineers (IEEE) 802.11 standards.

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

According to an embodiment of the invention, the wireless transceiver 210 may be configured in a modem (MD) of the communication apparatus 200, and the processor 220 may be configured in an application processor (AP) of the communication apparatus 200.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, when a voice call (e.g., voice over LTE (VOLTE) call, voice over NR (VoNR) call, or voice over Wi-Fi (VoWiFi) call) or a video call (e.g., video over LTE (ViLTE) call, video over NR (ViNR) call, or video over Wi-Fi (ViWiFi) call) needs to be performed between an apparatus (e.g., the UE 410 of FIG. 4 or the UE 420 of FIG. 4) and the other apparatus (e.g., the UE 420 of FIG. 4 or the UE 410 of FIG. 4) through a first connection. The apparatus may also establish a second connection with the other apparatus. In an example, the first connection may be a third generation partnership project (3GPP) connection and the second connection is a Wi-Fi connection. In another example, the first connection may be a Wi-Fi connection and the second connection is a 3GPP connection. For example, when the apparatus perform a voice call or a video call with the other apparatus through the 3GPP connection, the apparatus may also establish the Wi-Fi connection between the two apparatus.

According to an embodiment of the invention, when the apparatus performs the voice call or the video call with the other apparatus through the 3GPP connection, the two apparatus may respectively transmit its internet protocol (IP) information (e.g., Wi-Fi IP address) and port number information to a call exchange server (a voice call exchange server or a video call exchange server, e.g., the security real-time transport protocol (SRTP) switch server of FIG. 4) of the Wi-Fi network through the Wi-Fi connection, and establish a socket connection with the call exchange server through the Wi-Fi network. The call exchange server may record the IP information and the port number information of the two apparatus. The call exchange server may transmit the data packets (voice data packets or video data packets) of the voice call or the video call from the apparatus to the other apparatus according to the IP information and the port number information of the two apparatus, and may also transmit the data packets (voice data packets or video data packets) of the voice call or the video call from the other apparatus to the apparatus according to the IP information and the port number information of the two apparatus.

The apparatus may determine whether the first connection meets a quality condition while the apparatus performs the voice call or the video call with the other apparatus through the first connection. In an example, the quality condition may be that a quality of the first connection is lower than a threshold, e.g., the quality of service (QOS) of the first connection. In another example, the quality condition may be that the latency of the first connection is longer than a second threshold.

When the first connection meets a quality condition (i.e., the quality of the first connection is not good enough), the apparatus may transmit the data packets (voice data packets or video data packets) of the voice call or the video call to the other apparatus through the first connection and the second connection. That is, when the first connection meets a quality condition (i.e., the quality of the first connection is not good enough), the apparatus may also transmit the duplicate data packets of the voice call or the video call to the other apparatus through the second connection.

According to an embodiment of the invention, the apparatus may transmit or receive the data packets of the voice call or the video call through the 3GPP connection based on the real-time transport protocol (RTP) and real-time transport control protocol (RTCP). Specifically, the encoded data packets of the voice call or the video call may be transmitted to the other apparatus through the 3GPP connection based on the RTP protocol and RTCP protocol, and the encoded data packets of the voice call or the video call may be received from the other apparatus through the 3GPP connection based on the RTP protocol and RTCP protocol.

The apparatus may also transmit or receive the data packets of the voice call or the video call through the Wi-Fi connection based on the RTP protocol and RTCP protocol. Specifically, the encoded data packets of the voice call or the video call may be transmitted to the other apparatus through the Wi-Fi connection based on the RTP protocol and RTCP protocol, and the encoded data packets of the voice call or the video call may be received from the other apparatus through the Wi-Fi connection based on the RTP protocol and RTCP protocol. In some embodiments, in order to increase the security of data packet transmission through the Wi-Fi connection, the apparatus may also transmit or receive the data packets of the voice call or the video call through the Wi-Fi connection based on the SRTP protocol and RTCP protocol.

According to an embodiment of the invention, when the first connection is a 3GPP connection and the second connection is a Wi-Fi connection, after the apparatus transmits the data packets of the voice call or the video call to the other apparatus through 3GPP connection, the apparatus may receive the first response data packets associated with the voice call or the video call from the second apparatus through the 3GPP connection. In addition, after the apparatus transmits the data packets of the voice call or the video call to the other apparatus through Wi-Fi connection, the apparatus may receive the second response data packets associated with the voice call or the video call from the second apparatus through the call exchange server.

Then, the apparatus may merge the first response data packets and the second response packets, and play the merged data packets (e.g., display the video data or play the audio (voice) data) to perform the voice call or the video call. Specifically, the apparatus may compare the first response data packets to the second response data packets to determine whether there is any duplicate (or the same) data packet (i.e., the redundancy data packet) between the first response data packets to the second response data packets. If there are redundancy data packets between the first response data packets to the second response data packets, the apparatus may remove the redundancy data packets between the first response data packets and the second response data packets, and then merge the first response data packets and the second response packets.

According to an embodiment of the invention, when the second response data packets from the other apparatus are encoded based SRTP protocol, the apparatus may decode the second response packets to convert SRTP data packets into the RTP data packets.

According to an embodiment of the invention, when the first connection does not meet the quality condition (i.e., the quality of the first connection has been good enough), the apparatus may stop transmitting the data packets of the voice call or the video call to the other apparatus through the second connection. That is, the apparatus may stop transmitting or receiving the data packets of the voice call or the video call through dual-paths (i.e., first connection and second connection). The apparatus may perform the voice call or the video call with the second apparatus only through the first connection.

According to an embodiment of the invention, when the first connection is a 3GPP connection and the second connection is a Wi-Fi connection, after the voice call or the video call has been terminated, the apparatus and the other apparatus may also terminate the socket connection with the call exchange server.

FIG. 4 is a schematic diagram illustrating a dual-path call data transmission 400 according to an embodiment of the invention. The UE 410 and the UE 420 may be applied to the communicate apparatus 120 of FIG. 1. The eNB (or gNB) and Wi-Fi hotspot may be applied to the network node 110 of FIG. 1. As shown in FIG. 4, the UE 410 may perform a voice call or a video call with the UE 420 through the 3GPP connection. The UE 410 may also establish a Wi-Fi connection with the UE 420 while performing the voice call or the video call with the UE 420 through the 3GPP connection. When the 3GPP connection meets a quality condition (i.e., the quality of the first connection is not good enough), the UE 410 may transmit the data packets (voice data packets or video data packets) of the voice call or the video call to the UE 420 through the 3GPP connection and the Wi-Fi connection. That is, when the 3GPP connection meets a quality condition (i.e., the quality of the first connection is not good enough), the UE 410 may also transmit the duplicate data packets of the voice call or the video call to the UE 420 through the Wi-Fi connection.

FIG. 5 is a schematic diagram illustrating dual-path call data transmission 500 on an Android platform according to an embodiment of the invention. The dual-path call data transmission 500 of FIG. 5 is applied on the Android platform, but the invention should not be limited thereto. As shown in FIG. 5, according to an embodiment of the invention, the radio interface layer daemon (RILD) may be configured to control the communication between application layer and the modem layer of an UE.

When the UE performs a voice call (e.g., VOLTE call or VoNR call) with another UE through a first connection, the RILD may determine whether the first connection meets a quality condition (i.e., whether the quality of the first connection is good enough). When the first connection meets the quality condition (i.e., the quality of the first connection is not good enough), the RILD may enable the audio RTP/RTCP module to perform the dual-path call data transmission. When the first connection does not meet the quality condition (i.e., the quality of the first connection is good enough), the RILD may disable the audio RTP/RTCP module to perform the dual-path call data transmission. The audio RTP/RTCP module may perform the transmission based on the RTP protocol and RTCP protocol. Specifically, the audio RTP/RTCP module may control the transmission of the data packets encoded by the audio encode module through the first connection and the second connection. For example, the audio RTP/RTCP module may transmit the encoded audio data packets through the 3GPP connection based on the RTP/RTCP protocol, IP multimedia subsystem (IMS) protocol and Transmission Control Protocol/Internet Protocol (TCP/IP) protocol. In addition the audio RTP/RTCP module may transmit the duplicated encoded audio data packets through the Wi-Fi connection based on the RTP/RTCP protocol and the TCP/IP protocol. In addition, the audio RTP/RTCP module may also be configured to merge the audio data packets from the 3GPP connection and the Wi-Fi connection. Specifically, the audio RTP/RTCP module may merge the audio data packets from the cell network barer (based on IMS protocol) and the audio data packets from the Wi-Fi network bearer (based on TCP/IP protocol). Then, the audio RTP/RTCP module may transmit the merged audio data packets to the audio decode module to decode the merged audio data packets.

When the UE performs a video call (e.g., ViLTE call or ViNR call) with another UE through a first connection, the RILD may determine whether the first connection meets a quality condition (i.e., whether the quality of the first connection is good enough). When the first connection meets the quality condition (i.e., the quality of the first connection is not good enough), the RILD may enable the video RTP/RTCP module to perform the dual-path call data transmission. When the first connection does not meet the quality condition (i.e., the quality of the first connection is good enough), the RILD may disable the video RTP/RTCP module to perform the dual-path call data transmission. The video RTP/RTCP module may perform the transmission based on the RTP protocol and RTCP protocol. Specifically, the video RTP/RTCP module may control the transmission of the data packets encoded by the video encode module through the first connection and the second connection. For example, the video RTP/RTCP module may transmit the encoded video data packets through the 3GPP connection based on the RTP/RTCP protocol, IMS protocol and TCP/IP protocol. In addition the video RTP/RTCP module may transmit the duplicated encoded video data packets through the Wi-Fi connection based on the RTP/RTCP protocol and the TCP/IP protocol. In addition, the video RTP/RTCP module may also be configured to merge the video data packets from the 3GPP connection and the Wi-Fi connection. Specifically, the video RTP/RTCP module may merge the video data packets from the cell network barer (based on IMS protocol) and the video data packets from the Wi-Fi network bearer (based on TCP/IP protocol). Then, the video RTP/RTCP module may transmit the merged video data packets to the video decode module to decode the merged video data packets.

FIG. 6 is a flow chart illustrating a call data transmission method 600 according to an embodiment of the invention. The call data transmission method can be applied to the wireless communication system 100. As shown in FIG. 6, in step S610, an apparatus (e.g., the communication apparatus 120 of wireless communication system 100) may establish a first connection and a second connection with a second apparatus, wherein the first connection may be a 3GPP connection and the second connection is a Wi-Fi connection, or the first connection is a Wi-Fi connection and the second connection may be a 3GPP connection

In step S620, the apparatus may perform a voice call or a video call with the second apparatus through the first connection.

In step S630, the apparatus may determine whether the first connection meets a quality condition.

In step S640, the apparatus may transmit the data packets of the voice call or the video call to the second apparatus through the first connection and the second connection in the event that the first connection meets a quality condition.

According to an embodiment of the invention, in the call data transmission method, the quality condition may be at least one of that a quality of the first connection is lower than a threshold, and the latency of the first connection is longer than a second threshold.

According to an embodiment of the invention, in the call data transmission method, the apparatus may transmit the IP information and port number information of the apparatus to a call exchange server through the Wi-Fi connection.

According to an embodiment of the invention, in the call data transmission method, in the event that the first connection is a 3GPP connection and the second connection is a Wi-Fi connection, the apparatus may receive the first response data packets associated with the voice call or the video call from the second apparatus through the 3GPP connection, and receive the second response data packets associated with the voice call or the video call from the second apparatus through a call exchange server.

According to an embodiment of the invention, in the call data transmission method, the apparatus may merge the first response data packets and the second response packets, and play the merged data packets to perform the voice call or the video call.

According to an embodiment of the invention, in the call data transmission method, the apparatus may compare the first response data packets to the second response data packets, and remove the redundancy data packets between the first response data packets and the second response data packets.

According to an embodiment of the invention, in the call data transmission method, the second response data packets are encoded based on a SRTP.

According to an embodiment of the invention, in the call data transmission method, the apparatus may decode the second response packets to convert SRTP data packets into real-time transport protocol (RTP) data packets.

According to an embodiment of the invention, in the call data transmission method, the apparatus may stop transmitting the data packets of the voice call or the video call to the second apparatus through the second connection in the event that the first connection does not meet the quality condition. In addition, the apparatus may perform the voice call or the video call with the second apparatus only through the first connection.

According to the call data transmission method provided in the invention, when the voice call or video call performed on a first connection (e.g., 3GPP connection) and the quality of the first connection becomes worse, the apparatus may enable the dual-path transmission to perform the voice call or video call performed on the first connection (e.g., 3GPP connection) and a second connection (e.g., Wi-Fi connection) to maintain the quality of the voice call or video call and avoid the voice call or video call is dropped.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A call data transmission method, comprising:
establishing, by a processor of an apparatus, a first connection and a second connection with a second apparatus, wherein the first connection is a third generation partnership project (3GPP) connection and the second connection is a Wi-Fi connection, or the first connection is a Wi-Fi connection and the second connection is a 3GPP connection;
performing, by the processor, a voice call or a video call with the second apparatus through the first connection;
determining, by the processor, whether the first connection meets a quality condition; and
transmitting, by the processor, data packets of the voice call or the video call to the second apparatus through the first connection and the second connection in an event that the first connection meets the quality condition.

2. The call data transmission method of claim 1, wherein the quality condition comprises at least one of that a quality of the first connection is lower than a threshold, and a latency of the first connection is longer than a second threshold.

3. The call data transmission method of claim 1, further comprising:
transmitting, by the processor, an internet protocol (IP) information and a port number information of the apparatus to a call exchange server through the Wi-Fi connection.

4. The call data transmission method of claim 1, wherein in an event that the first connection is the 3GPP connection and the second connection is the Wi-Fi connection, the method further comprises:
receiving, by the processor, first response data packets associated with the voice call or the video call from the second apparatus through the 3GPP connection; and
receiving, by the processor, second response data packets associated with the voice call or the video call from the second apparatus through a call exchange server.

5. The call data transmission method of claim 4, further comprising:
merging, by the processor, the first response data packets and the second response packets; and
playing, by the processor, merged data packets to perform the voice call or the video call.

6. The call data transmission method of claim 5, further comprising:
comparing, by the processor, the first response data packets to the second response data packets; and
removing, by the processor, redundancy data packets between the first response data packets and the second response data packets.

7. The call data transmission method of claim 4, wherein the second response data packets are encoded based on a security real-time transport protocol (SRTP).

8. The call data transmission method of claim 7, further comprising:
decoding, by the processor, the second response packets to convert SRTP data packets into real-time transport protocol (RTP) data packets.

9. The call data transmission method of claim 1, further comprising:
stopping, by the processor, transmitting the data packets of the voice call or the video call to the second apparatus through the second connection in an event that the first connection does not meet the quality condition; and
performing, by the processor, the voice call or the video call with the second apparatus only through the first connection.

10. An apparatus, comprising:
a transceiver, configured to perform wireless transmission and reception to and from a network node; and
a processor, coupled to the transceiver, and performing operations comprising:
establishing a first connection and a second connection with a second apparatus, wherein the first connection is a third generation partnership project (3GPP) connection and the second connection is a Wi-Fi connection, or the first connection is a Wi-Fi connection and the second connection is a 3GPP connection;
performing a voice call or a video call with the second apparatus through the first connection;
determining whether the first connection meets a quality condition; and
transmitting, via the transceiver, data packets of the voice call or the video call to the second apparatus through the first connection and the second connection in an event that the first connection meets the quality condition.

11. The apparatus of claim 10, wherein the quality condition comprises at least one of that a quality of the first connection is lower than a threshold, and a latency of the first connection is longer than a second threshold.

12. The apparatus of claim 10, wherein the processor performs operations comprising:
transmitting, via the transceiver, an internet protocol (IP) information and a port number information of the apparatus to a call exchange server through the Wi-Fi connection.

13. The apparatus of claim 10, wherein in an event that the first connection is the 3GPP connection and the second connection is the Wi-Fi connection, the processor performs operations comprising:
receiving, via the transceiver, first response data packets associated with the voice call or the video call from the second apparatus through the 3GPP connection; and
receiving, via the transceiver, second response data packets associated with the voice call or the video call from the second apparatus through a call exchange server.

14. The apparatus of claim 13, wherein the processor performs operations comprising:
merging the first response data packets and the second response packets; and
playing merged data packets to perform the voice call or the video call.

15. The apparatus of claim 14, wherein the processor performs operations comprising:
comparing the first response data packets to the second response data packets; and
removing redundancy data packets between the first response data packets and the second response data packets.

16. The apparatus of claim 13, wherein the second response data packets are encoded based on a security real-time transport protocol (SRTP).

17. The apparatus of claim 16, wherein the processor performs operations comprising:
decoding the second response packets to convert SRTP data packets into real-time transport protocol (RTP) data packets.

18. The apparatus of claim 9, wherein the processor performs operations comprising:
stopping transmitting the data packets of the voice call or the video call to the second apparatus through the second connection in an event that the first connection does not meet the quality condition; and
performing the voice call or the video call with the second apparatus only through the first connection.
